(19) United States
(12) Patent Application Publication
(10) Pub. No.: US 2002/0099589 A1
(43) Pub. Date: Jul. 25, 2002

(54) Method for providing home-cooked ethnic dishes by native-trained chefs through a chef agency

(76) Inventor: Bronwyn C. Rice, Portland, OR (US)

Correspondence Address: Ingrid M. McTaggart, 702 S.E. 5th Ave., Hillsboro, OR, 97123, US

(21) Appl. No.: 09/768,939

(22) Filed: Jan. 23, 2001

(51) Int. Cl. G06F 17/60

(52) U.S. Cl. 705/9; 705/26

(57) ABSTRACT

A chef agency includes a database of information relating to native-trained chefs, and a database of information relating to a client and the client's dietary and other needs. Clients access the agency database to schedule an in-home ethnic meal prepared by a native chef. The agency contacts the appropriate chef and provides relevant client information to the chef. The agency may also provide specialized supplies to the chef prior to preparation of the meal. The agency system can be fully automated so that client's requests are automatically forwarded to an appropriate chef for scheduling.

### TECHNICAL FIELD

The present invention relates to a method of providing home-cooked ethnic dishes by native-trained chefs through a chef agency and, more particularly, to a method of providing a customer with an array of ethnic dish choices wherein each ethnic dish is prepared in the customer's home by a native-trained chef.

### BACKGROUND OF THE INVENTION

In today's fast-paced world, many people do not have the time to shop for groceries, cook healthy and fulfilling meals, and clean up after their cooking. Moreover, very few people have the time, expertise, or supplies, such as exotic spices and specialized cooking utensils, necessary to prepare authentic ethnic cuisine such as Italian, Thai, Vietnamese, Chinese, Indian, Mexican, French, Southern American, or other such specialized dishes. Additionally, many people have special dietary needs, such as diabetic or allergy restraints, which prohibit these people from eating ethnic cuisine at restaurants.

Accordingly, in the past several years, the phenomenon of personal chefs has become more popular. The typical personal chef is professionally trained at a culinary institute and is hired by a family to cook the family's meals. The same chef typically cooks each meal, regardless of the type of dish being prepared. Accordingly, the chef may not have the proper utensils for a particular type of ethnic dish, may not have the knowledge of local markets to purchase fresh and authentic supplies, and typically does not specialize in the particular ethnic dish being prepared. Moreover, the chef typically has not been informally trained in the country of the particular ethnic cuisine, but instead has been formally trained at a cooking school in the United States. Personal chefs, therefore, do not provide a family with authentic ethnic dishes prepared in the family's home by cooks trained informally in their own native country. If the family desires a native chef for preparation of each of a variety of ethnic dishes, the family is required to contact multiple chefs individually. This task may be quite difficult because many native, informally trained chefs are not connected in typical business circles and may not speak the language of the customer. The time required to contact, screen, and impart relevant information, such as special dietary needs or dislikes, can defeat the time-saving purpose of hiring a variety of native-trained personal chefs.

Accordingly, there is a need for a culinary agency which provides a variety of native-trained chefs, i.e., chefs trained informally in their native country, for preparing authentic ethnic dishes in a family's home. Moreover, there is a need for a culinary agency which provides a family with the ease of a single source for providing a variety of food preparers, each food preparer trained in the preparation of a particular ethnic cuisine, and each possessing the dietary information previously provided to the agency by the customer in a single initial interview.

### SUMMARY OF THE INVENTION

An object of the present invention is to provide a method of supplying customers with native-trained chefs through a culinary agency.

Another object of the present invention is to provide a culinary agency that provides customers with a selection of native-trained chefs wherein each chef is trained in the preparation of a particular ethnic cuisine.

Still a further object of the present invention is to provide a culinary agency that provides a customer with a single source for supplying personal chefs, wherein the agency maintains a record of the special dietary requirements and desires of the customer.

Accordingly, the invention preferably comprises a culinary agency that includes a customer base and a selection of native-trained chefs. Each customer in the customer base fills out appropriate forms at an initial interview so that the agency can determine and record the special dietary needs of the customer, such as needs relating to diabetic conditions, allergies, food dislikes (such as an aversion to a particular food), wheat-free or vegetarian needs, and preferences, such as mild or spicy. In another method, the agency simply speaks with the customer on the telephone or in person to gather the relevant information. The agency also will record the customer's preference for meal times, entry methods into the customer's house, the supplies on hand at the customer's house, and other pertinent information individual to the customer. The agency further includes information on a selection of native-trained chefs, such as information relating to criminal background checks, the country in which the chef was native-trained, cooking utensils owned by the chef, the dates and times the chef is willing to prepare meals, and other pertinent information related to the individual chefs.

In the method of the present invention, the agency acts as a single information source connecting customers with a variety of native-trained chefs. Accordingly, the customer is subjected to only a single introductory interview, and thereafter, the customer may hire a variety of native-trained chefs with only a single call to the agency. The initial interview, as stated above, may comprise a lengthy person-to-person interview or may comprise a relatively quick telephone conversation. The agency coordinates the client's information with the chef so that for each ethnic meal prepared in the customer's home, the chef will come prepared with the information related to the client's needs and desires and with the required utensils and supplies. The agency, therefore, provides their busy customers with healthy ethnic meals prepared in the customer's home by a native-trained cook, tailored to their specific needs, with only a single call by the customer.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a schematic diagram showing the connection of the customers, the agency and the chefs;

FIG. 2 is a table showing information received from a client in an initial interview;

FIG. 3 is a table showing information received from a chef in an initial interview; and

FIG. 4 is a schematic diagram of one of the possible communication networks of the method of the present invention.

### DETAILED DESCRIPTION

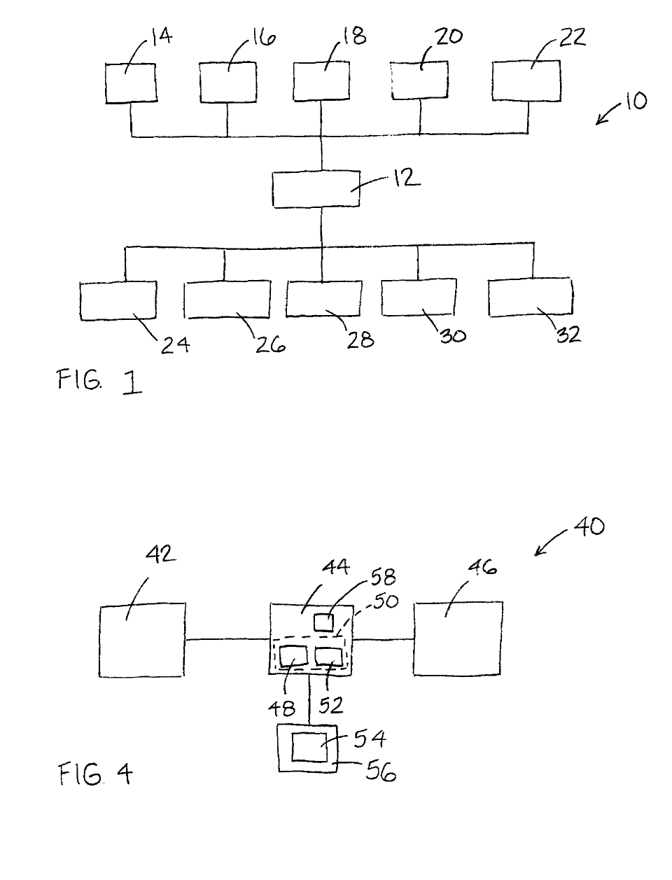

Referring now to the figures, FIG. 1 is a schematic diagram showing the connection of the customers, the agency and the chefs. In particular, agency setup 10 includes a chef agency 12 connected to multiple customers 14, 16, 18, 20 and 22, and connected to multiple chefs 24, 26, 28, 30 and 32. Of course, the agency may be connected to any number of customers, and to any number of chefs. Moreover, some of the chefs may be customers, and vice versa. Accordingly, agency 12 acts as an information storehouse and as a middleman or connection point between the native chefs and the customers. The agency may also act as a warehouse for supplies, as will be more fully described below.

In particular, customer 14 may comprise a family of four wherein both parents work outside the home and do not have time to shop, prepare, and then clean up after a healthy home-cooked ethnic meal. Customer 16 may comprise a business person that frequently travels and does not have the time to shop or cook. Client 18 may comprise an elderly couple that cannot easily cook for themselves. Customer 20 may comprise an affluent person that likes to sample a variety of native dishes. Customer 22 may be a business enterprise that conducts formal dinner meetings for its own clients. Other clients may comprise any individuals or groups that desire to hire a personal chef to cook an ethnic dish wherein the chef is native-trained.

The term “native-trained chef,” for purposes of the present invention, is defined as a chef that has been trained informally in the cooking style of their own ethnic ancestry. Accordingly, a native-trained chef, for purposes of the present invention, has not been formally trained in a cooking school or a culinary institute, but instead has been informally trained by their parents, other relatives or friends, or in a local restaurant in their native country. Native-trained chefs may be immigrants recently having arrived in the United States from their native country. These native-trained chefs may not speak English and typically do not have business connections upon arriving in the United States. When a customer contacts agency 12 to have a chef prepare an in-home cooked meal, the customer knows that the chef will be preparing authentic meals prepared in accordance with old family recipes and traditions which the chef has learned firsthand while being raised and immersed in their native culture.

For example, chef 24 may comprise a chef born and raised in Mexico and trained to cook Mexican food by her mother. Chef 26 may comprise a food preparer raised in France and trained to cook French cuisine by his aunt. Chef 28 may be a chef born in the United States and trained to cook Thai food by his parents, natives of Thailand. Cook 30 may be of East Indian ancestry and learned to cook East Indian food by working in many restaurants while being raised in India. Chef 32 may be of Greek ancestry and trained to cook Greek dishes by her father. Other chefs may comprise individuals of any ethnic origin wherein the chefs each have been native trained in their cooking skills. Accordingly, Vietnamese cooks have been native trained to cook Vietnamese food such as Pad Thai, Italian cooks have been native trained to cook Italian food such as pasta and a variety of sauces, and American cooks raised in the deep South have been native trained to cook American Southern food such as Gumbo and Jambalaya. In other examples, the chef may be a New Englander that has been native-trained to cook New England food such as lobster or clam chowder, or a Japanese chef that has been native-trained to prepare sushi or tempura. In other examples, the cooks may have an ethnic ancestry such as Chinese, Russian, American Indian, Jamaican, Brazilian, German, Danish, Spanish, British, Ethiopian, Scottish, Irish, Belgian, Korean, or any other such ancestry having a unique ethnic cuisine or dishes.

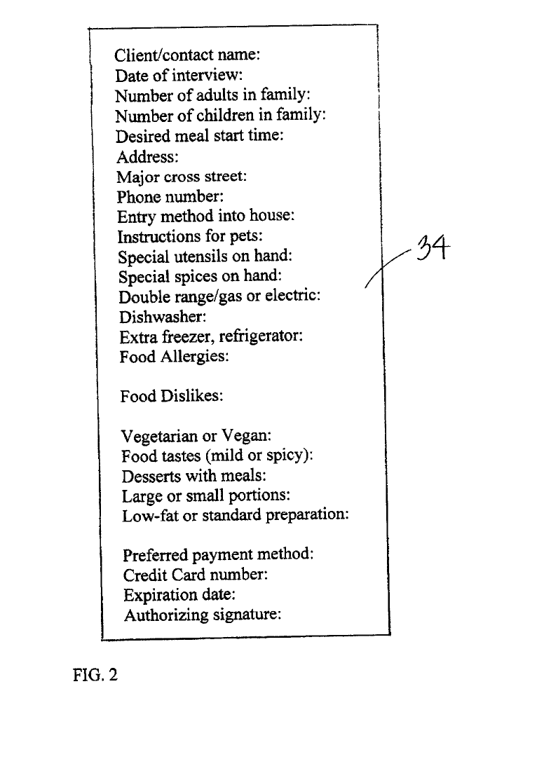

FIG. 2 is a table 34 showing information received from a client by the agency in an initial interview. Table 34, also called a customer questionnaire, comprises a list of questions typically asked during an initial conference between the agency and a particular client. The interview questions typically will ask for the following information: client/contact name; date of the interview; number of adults in family; number of children in family; desired meal start time; address of the client; major cross street nearest the client's home; telephone number; entry method into house (i.e., where is a key hidden, or contact information to let the chef into the house); instructions for dealing with pets that may be present; special utensils on hand such as woks, food processors, or the like; special spices on hand; the presence of a double range or a gas stove; presence of a dishwasher; presence of an extra freezer or a refrigerator; food allergies any member of the client family may have; any food dislikes or religious restrictions, such as a dislike of onions or a constraint against the use of pork; whether the client is a vegetarian or a vegan; whether the client prefers food mild or spicy; whether the client likes the meal to include desserts; whether the client prefers large or small portions or whether leftovers are desired; and whether the client prefers low-fat or standard preparation of the food. Of course, any other such questions related to having a personal chef cook an ethnic dish in the client's home IS may also be included on the initial client interview questionnaire. The questionnaire typically also includes information related to payment, such as by check or by credit card, and may include a credit card authorization signature which will be kept on file with the agency.

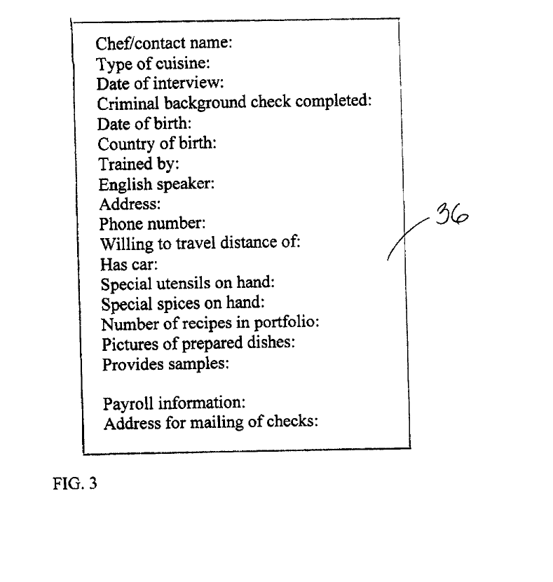

FIG. 3 is a table 36 showing information received from a chef by the agency in an initial interview. Table 36, also called a chef questionnaire, comprises a list of questions typically asked during an initial conference between the agency and a particular chef. The interview questions typically will ask for the following information: the chef s name; the type of cuisine the chef cooks; the date of the interview; the chef s social security number so as to conduct a criminal background check; the date of birth of the chef, the country of birth; who the chef was trained by, such as their mother, father, friend, or neighborhood restaurant owner; is the chef an English speaker; the address of the chef; the chefs telephone number; the distance the chef is willing to travel to a client; whether the chef has a car; special utensils owned by the chef; special spices owned by the chef; the number of recipes in the chef's portfolio; does the chef have pictures of prepared dishes for placement on a web site or in a brochure (during the initial interview of the chef, the agency may also take pictures of the chef or the chef s food samples for display to customers); and does the chef provide samples to prospective customers (though typically the chef will only provide samples of their culinary skills to the agency upon beginning of the relationship between the chef and the agency). Of course, any other such questions related to having the native chef cook an ethnic dish in a client's home may also be included on the initial chef interview questionnaire. The questionnaire may also include information related to payroll, such as where checks should be mailed or if the chef will pick up paychecks personally. The questionnaire may also include relevant tax information for the agency for preparing payroll paperwork.

FIG. 4 is a communication system of the present invention. System 40 preferably comprises a computer 42 at a client's location, a central computer 44 at an agency location, and a computer 46 at the chef s location. In one embodiment, the client information obtained from questionnaire 34, shown in FIG. 2, is placed in a client database 48 stored at the agency's central computer 44, and is accessible through the agency's web site, represented by component 50. The chefs information obtained from questionnaire 36, shown in FIG. 3, is placed in a chef database 52 and is also stored at the agency's central computer 44, and is accessible through the agency's web site 50. The communication system further includes a warehouse database 54 that includes a list of the current contents of an agency warehouse 56. The warehouse database 54 typically is connected to web site 50 so that it can be accessed through the agency web site. In other methods or embodiments, the utensils, spices or other needed supplies can be stored at the agency office or at any suitable location, such as at the chef s home or office.

In one embodiment, warehouse 56 houses professional-sized cooking containers such as pots, pans, strainers, serving pans, mixers, and the like. The warehouse may also store unique spices for the ethnic dishes so that each individual chef is not required to purchase fresh spices each time they are hired to prepare a meal. This central warehouse, therefore, allows expensive cooking utensils and spices to be purchased by the agency in bulk and used by each of the chefs. This allows these expensive items to be used by multiple cooks so that the cost of the items is not prohibitive for each individual chef. In other embodiments or methods, the client may have some or all of the needed utensils, spices or other supplies on hand at their home.

In one embodiment, wherein any of the client, the chef, or the agency, do not have a computer, any of communication apparatus 42, 44 and 46 may comprise simple telephones, in-person communications, or communications placed through the regular mail system, and databases 48 and 52 may comprise a standard hardcopy database, i.e., a paper filing system. In the embodiment wherein any of the communication apparatus comprise telephones, the client typically will call an agent at the agency to place an order for a native-cooked in-home meal and the agent will look up the necessary information in the file database.

Still referring to FIG. 4, in one embodiment wherein the system comprises computers connected to the worldwide web, the client may browse the chef database located on the agency web page. Through the agency database, the client can review: the types of ethnic cuisine available; pictures and biographies of each of the chefs affiliated with the agency; pictures of sample dinners for each chef; the portfolio of recipes of each of the chefs; the types of food supplies the chef likes to work with (such as lentils, pasta, and the like) the nutritional and ingredient information on each dish; and the preferred schedule of each of the chefs. The client may then send an electronic message, e.g., an email, to the agency requesting a meal on a certain date and at a certain time. The client may specify the type of ethnic cuisine, the exact chef, or even the exact dish as chosen from the chefs portfolio. This message may be automatically forwarded by the agency communication system to the chef chosen by the client. If no chef is chosen, a software scheduling program 58 of the agency computer system may match up the desired time, date and ethnic cuisine with an available chef. The agency communication system will then automatically schedule and contact the chef regarding the scheduled meal, and confirm with the client that the chef has been booked for the meal. In another embodiment, scheduling program 58 comprises an agency employee manually scheduling and contacting the chef and the client.

Once a chef has been scheduled to prepare a meal, the chef may access the client database on the agency web site to determine what specific dietary needs the client may have, how to access the client's home, and directions to the client's home from the nearest main intersection. Of course, the agency web site will typically be secured so that private information such as the client's medical condition and methods of entry into the client's home will not be accessible to the general public. The chef will also be able to determine what specialized utensils and spices are available at the agency storage location, or the client's home, and what spices and utensils the chef must provide or purchase. Using reservation software of the agency communication system, the chef can reserve the needed equipment and supplies, which may be stored at the agency warehouse. The communication system may also allow the chef to order the necessary supplies from the warehouse for pick-up or delivery to the chef at a predetermined pick-up time. Accordingly, the agency of the present invention provides a communication link between the client and the chef, and between the chef and the supply warehouse.

With reference to all the figures, the method of the present invention will be further described. The chef agency compiles a client database including multiple clients. Of course, the database in its initial stages may include only one client. Each client will be interviewed by an agent of the agency. In a fully electronic method, the client may log on to the agency web site and proceed with a self-paced question and answer session wherein the client types the answers to each question on their computer. Software of the agency communication system places the client's answers in table format for storage or retrieval from the client database. In such an embodiment, no agent is required to review the questionnaire with the client.

The client database typically is updated throughout the life of the agency business so that new clients can be added at any time and clients no longer using the services can be deleted from the database. Moreover, client information can be changed if the client's dietary needs change. The questionnaire of FIG. 2 typically is used as a guide for the interview. These questions will be relevant for each type of ethnic cuisine that will be prepared in the client's home. Accordingly, the client need only be asked these questions once, at the beginning of the agency relationship. Once the client information has been compiled, the information is stored in client database 48 so that the information for each client can be easily retrieved. This allows clients to simply call the agency at a later date and specify the date and type of ethnic cuisine desired. The agency does the rest of the setup work including contacting a chef and relaying the necessary information to the chef.

In one embodiment, the client information is stored on a secure web site that can be accessed by each of the native chefs. Accordingly, the agency merely contacts a chef and informs the chef that a particular client has requested a meal of ethnic origin that matches the ethnic origin of the chef. The chef then retrieves the client's information on the web site, begins shopping for the appropriate supplies, and then prepares the meal at the client's home. The chef can access the client's home based on instructions provided on the secure web site. Moreover, the chef has all the relevant dietary needs information from the client database before the chef begins purchasing food supplies.

The chef agency also compiles chef database 52 including multiple chefs. Each chef will be interviewed by an agent of the agency, or may input the information directly in a self-paced, computerized question and answer session. Of course, the preferred business method is to interview the chef candidates in person before the agency agrees to placing them in home cooking situations. The questionnaire of FIG. 3 typically is used as a guide for the interview. The chef database typically is updated throughout the life of the agency business so that new chefs can be added at any time and chefs no longer available can be deleted from the database. The questions asked during the interview will be relevant each time the chef is hired to prepare a meal in a client's home. Accordingly, the chef need only be asked these questions once, at the beginning of the agency relationship. Once the chef information has been compiled, the information is stored in a chef database so that the information for each chef can be easily retrieved. In one embodiment, the chef information is stored on a secure web site which clients are allowed to access. This allows clients to browse the chef database and to choose chefs whom they would like to prepare a meal in their home. The database may also include pictures and short biographies of the chefs, and pictures of meals prepared by the cooks. Accordingly, the agency does the setup work of bringing the clients into contact with information regarding each chef. The chefs, therefore, are not required to repeat the same information for each prospective client.

The present invention provides a time-saving advantage to customers in that only one call is needed to order a home-cooked ethnic meal. The present invention further provides an advantage to recent immigrants to the United States in that informally trained cooks will be provided with a valuable business connection for their services.

While preferred embodiments of the present invention have been shown and described, it will be apparent to those skilled in the art that many changes and modifications may be made without departing from the invention in its broader aspects. The appended claims are intended to cover, therefore, all such changes and modifications as fall within the true spirit and scope of the invention.

I claim:

1. A method of providing ethnic meals prepared in a client's home by a native-trained chef, comprising the steps of:
compiling information on a client including the client's dietary requirements;
compiling a database of information on a plurality of native-trained chefs including the ethnic ancestry of each chef, wherein each of the native-trained chefs has been informally trained to cook;
providing a central communication agency which links the information compiled on the client with the database of information on the plurality of native-trained chefs;
initiating contact from the client to the central communication agency wherein the client orders an ethnic dish to be prepared for the client at a location chosen by the client;
scanning the database to choose a native-trained chef suited to prepare the ethnic dish for said client wherein the ethnic ancestry of said chosen native-trained chef matches an ethnicity of said ethnic dish; and
initiating contact from the central communication agency to said chosen native-trained chef to schedule said chosen native-trained chef to prepare the ethnic dish for said client.

2. The method of claim 1 wherein said step of initiating contact from said client to the central communication agency is conducted by a method chosen from the group consisting of a calling on a telephone, accessing via a computer, contacting in-person, and preparing a letter.

3. The method of claim 1 wherein said step of compiling information on a client further comprises gathering information from the group consisting of the client's name, the date of the information compilation, the number of adults in the client's family, the number of children in the client's family, the desired meal start time, the address of the client, the major cross street nearest to the client's home, the telephone number of the client, the preferred entry method into the client's home, instructions for dealing with pets that may be present, special utensils owned by the client, special spices owned by the client, the presence of a double range at the client's location, the presence of a gas stove at the client's location, the presence of a dishwasher at the client's location, the presence of a freezer at the client's location, the presence of a refrigerator at the client's location, food allergies of the client, food dislikes of the client, religious food restrictions of the client, whether the client is a vegetarian or a vegan, whether the client prefers food mild or spicy, whether the client likes the meal to include desserts, whether the client prefers large or small portions, whether the client prefers that leftovers be available, whether the client prefers low-fat or standard preparation of the food, payment preferences of the client, and a credit card authorization signature.

4. The method of claim 1 wherein said step of compiling a database of information on a plurality of native-trained chefs further comprises gathering information on each chef, the information chosen from the group consisting of the chef s name, the type of cuisine the chef cooks, the date of the information compilation, the result of a criminal background check on the chef, the date of birth of the chef, the country of birth of the chef, how the chef was trained, whether the chef is an English speaker, the address of the chef, the chefs telephone number, the distance the chef is willing to travel to a client, whether the chef has a car, special utensils owned by the chef, special spices owned by the chef, the number of recipes in the chef's portfolio, pictures of dishes prepared by the chef, whether the chef provides samples to prospective customers, payroll information, and tax information.

5. The method of claim 1 further comprising the step of initiating contact from said chosen native-trained chef to said central communication agency wherein said chef accesses the information compiled on said client.

6. The method of claim 5 further comprising the step of said chosen native-trained chef traveling to the location chosen by said client and said chef preparing the ethnic dish ordered by said client, wherein said ethnic dish is prepared in accordance with the information compiled on said client.

7. The method of claim 5 wherein said step of initiating contact from said chosen native-trained chef to said central communication agency is conducted by a method chosen from the group consisting of a calling on a telephone, accessing via a computer, contacting in-person, and preparing a letter.

8. A chef agency communication system comprising:
a client database including client information on a plurality of clients, wherein said client information includes the dietary preferences of each client;
a chef database including chef information on a plurality of native-trained chefs, wherein said chef information includes the type of ethnic cuisine prepared by each chef; and
a communication apparatus which is adapted to allow a client to access said chef database, and which is adapted to allow a chef to access said client database.

9. The communication system of claim 8 wherein said communication apparatus includes scheduling software accessible by a client, wherein said software is connected to said chef database, said software facilitates said client in scheduling the preparation of an ethnic meal, and at a request by said client said software schedules one of said plurality of said native-trained chefs to prepare said ethnic meal for said client.

10. The communication system of claim 8 wherein said communication apparatus includes a web site and wherein said client database and said chef database are accessible on said web site.

11. The communication system of claim 8 wherein said communication apparatus includes a warehouse inventory database including information related to an inventory of a culinary storage location.

12. The communication system of claim 8 wherein said communication apparatus includes a client computer, a chef computer, and a central computer which stores said client database and said chef database, and wherein said client computer and said chef computer communicate with each other via said central computer.

13. The communication system of claim 8 wherein said communication apparatus includes a telephone and a central computer which stores said client database and said chef database.

14. A method of scheduling a home-cooked ethnic meal through an agency, comprising the steps of:
a customer contacting a culinary agency and ordering a home-cooked ethnic meal;
said culinary agency searching a chef database to schedule a native-trained chef to prepare said home-cooked ethnic meal for said customer;
said culinary agency contacting said native-trained chef to inform said native-trained chef of said schedule;
said native-trained chef receiving from said culinary agency information regarding said customer's dietary requirements; and
said native-trained chef preparing a home-cooked ethnic meal for said customer at said cutomer's location, wherein said home-cooked ethnic meal is prepared by said native-trained chef in accordance with said customer's dietary requirements.

15. The method of claim 14 further comprising the step of said native-trained chef purchasing supplies for the preparation of said home-cooked ethnic meal, wherein said supplies are purchased in accordance with said customer's dietary requirements.

16. The method of claim 14 further comprising the step of said native-trained chef cleaning up said client's location after preparation of said home-cooked ethnic meal.

17. The method of claim 14 further comprising the step of said native-trained chef reserving the use of supplies owned by said culinary agency.

18. The method of claim 14 further comprising the step of compiling said client database including client information on a plurality of clients, wherein said client information includes the dietary preferences of each client.

19. The method of claim 14 further comprising the step of compiling said chef database including chef information on a plurality of native-trained chefs, wherein said chef information includes a type of ethnic cuisine prepared by each chef.

20. The method of claim 14 further comprising receiving payment from the client to said agency, and forwarding at least a portion of said payment from said agency to said chef.
